(19) United States
(12) Patent Application Publication
(10) Pub. No.: US 2011/0046761 A1
(43) Pub. Date: Feb. 24, 2011

(54) Recorded Media Enhancement Method

(76) Inventors: Paul Frederick Titchener, Brisbane, CA (US); Mark Robert Kaplan, Mount Hood Parkdale, OR (US)

Correspondence Address: Paul Frederick Titchener, 100 North Hill Dr., #24, Brisbane, CA, 94005, US

(21) Appl. No.: 12/858,391

(22) Filed: Aug. 17, 2010

Related U.S. Application Data
(60) Provisional application No. 61/235,335, filed on Aug. 19, 2009.
(60) Provisional application No. 61/245,219, filed on Sep. 23, 2009.
(60) Provisional application No. 61/262,120, filed on Nov. 17, 2009.

(51) Int. Cl. G06F 17/00

(52) U.S. Cl. 700/94

(57) ABSTRACT

A media processing method that dramatically improves the perceived audio quality and audio output level and video quality and video display consistency for most commonly used audio and video recording, storage and playback systems. The system synthesizes and boosts harmonics and spectral ranges that have been diminished or are missing in the audio component of media files and also processes the audio component to allow maximum playback level without distortion, while also insuring that the perceived audio playback level between different media files stays consistent. The system also improves the listening experience for users of headphones or ear buds. The system also improves the video image color range and brightness for best display on particular display devices while also insuring that the image brightness and color intensity stays consistent even when viewing media files containing video from a variety of different sources.

### RELATED APPLICATIONS

The present application is a continuation-in-part application of U.S. provisional patent application Ser. No. 61/235,335, filed Aug. 19, 2009, for RECORDED AUDIO ENHANCEMENT SYSTEM, GENERAL, by Paul F. Titchener, Mark Kaplan, included by reference herein and for which benefit of the priority date is hereby claimed.

The present application is a continuation-in-part application of U.S. provisional patent application Ser. No. 61/245,219, filed Sep. 23, 2009, for RECORDED MEDIA ENHANCEMENT SYSTEM, by Paul F. Titchener, Mark Kaplan, included by reference herein and for which benefit of the priority date is hereby claimed.

The present application is a continuation-in-part application of U.S. provisional patent application Ser. No. 61/262,120, filed Nov. 17, 2009, for RECORDED AUDIO ENHANCEMENT SYSTEM INCLUDING HEADPHONE ENHANCEMENTS, by Paul F. Titchener, Mark Kaplan, included by reference herein and for which benefit of the priority date is hereby claimed.

### FIELD OF THE INVENTION

The present invention relates to video an/or audio media recordings and, more particularly, to improving the perceived quality of media recordings.

### BACKGROUND OF THE INVENTION

The phrase recorded media will be used to refer to a recording that contains either audio or video content or a combination of audio and video content. For example an mp3 format file (the popular format detailed in the MPEG-1 Audio Layer 3 encoding specification) is an example of an audio media file. A Windows Media Video (.wmv) format file is an example of a combined audio-video media file.

Current systems for recording and encoding audio and video performances and activities all have limitations that reduce the perceived quality of the recordings upon decoding and playback. Typically there are multiple stages of data encoding, decoding and re-encoding performed on a media recording prior to it being decoded for viewing and listening by the end user. In the following example we will discuss in detail the process and associated limitations involved in recording an audio media file, but the process and associated limitations of recording a video file are very similar and we will summarize those limitations also.

With the most commonly used system for performing an audio recording the electrical outputs of one or more microphones or electric musical instruments are converted to digital signals through the use of an Analog to Digital (A/D) converter, and the digital signals then are stored on a digital disc or tape based multi-track recording system.

A particular encoding system is used to convert those original electrical signals into digital signals, and at this initial point in the recording process the Pulse Code Modulation (PCM) encoding system is typically used. As with any encoding system there is always some error introduced in the encoding process so that the encoded version is not a fully exact representation of the original sounds that created the recorded electrical signals. Typically the next step in the process is the mixing phase, where the multiple recorded audio tracks are individually decoded, summed together with any additional desired processing operations applied, such as equalization and reverberation, and then an additional step of encoding is performed, typically to create a two track stereo “mixdown” of the multiple audio tracks. At this mixdown point the encoded format will again typically be PCM, with bit accuracies typically ranging from 16 to 32 bits and sampling frequencies ranging from 44.1 to 192 kHz.

The recording process for video to this point is very similar, with typically a light sensitive charged coupled device (CCD) being used to sense the light captured through a lens and to convert the changing light intensity into an analog voltage representing the video image. Similar to the process described above that analog voltage is converted to a digital signal through the use of an A/D converter and then is then encoded into a format such as PCM. Similar to the audio mixing process described above, in the process of producing a final video recording a video mixer is typically used to mix and fade between multiple video tracks, requiring one or more decoding and re-encoding steps.

The next typical step in audio recording is called “mastering”. The mastering engineer, typically a specialist and not the original recording engineer, makes the final small adjustments on the stereo mix-down tracks, typically making small adjustments in equalization and level and applying various systems of audio compression that make the mix-down sound louder. The mastering engineer typically works on a full album of songs, and takes care to make sure that the relative volumes of all the songs in the album match closely, so that none of the songs in the album seem louder or softer than the other songs. This mastering step requires an additional decoding and re-encoding step so that the processing chosen by the mastering engineer can be applied to the mix-down, creating the “master” version. The format of the master version will typically be a 16 to 24 bit PCM version with a sampling frequency ranging from 44.1 to 192 khz.

For video production, the process analogous to audio mastering, which makes final adjustments on the video recording, is sometimes done at the same time as the video mixing process described above or can also be done as a final step similar to the audio mastering process. In either case adjustments are typically made to the brightness, contrast and color saturation of the video by the video engineer and this additional processing will typically require an additional step of decoding and re-encoding to create the master version of the video recording.

The next step in the audio recording process is to create the final delivery format of the song. This is done by decoding the master version and re-encoding it into the chosen format.

If the delivered format is to be an audio compact disc (CD), the stereo master version is decoded from the format described above and then is encoded to 16 bit PCM at a sampling rate of 44.1 kHz to create the CD master that is used to manufacture the final CDs.

If the delivered format is to be what is commonly called an “Mp3 file”, which is a popular format digital file that contains the stereo audio mixed down encoded using the MPEG-1 Audio Layer 3 encoding specification, then the encoding is typically a 128 kilo bit per second (kbps) or 256 kbps, 44.1 kHz sampling rate stereo file using an encoder that is compliant with that MPEG-1 specification. Note that many combined audio/video media formats use the mp3 audio format or a very similar format for the audio component of the combined media file.

Note that the Mp3 format employs data reduction in that the total number of stored bits required for the stored Mp3 file version of a recording is much smaller than those needed to store either the master version of the recording described above or the CD version of the recording. This is a significant advantage of the Mp3 format as the smaller storage size of the songs allows them to be downloaded from the internet much more quickly and also requires less storage space on the user's personal computer (PC) or portable Mp3 player.

However this reduction in size causes a well known and understood significant reduction in audio fidelity and accuracy. The encoding system used in the Mp3 format only uses high accuracy for sounds in the various frequency ranges that are currently louder than sounds in other frequency ranges. Thus sounds that are fully audible in the original song but not as loud as the louder sounds in the song are not encoded with as much accuracy. This encoding system causes a significant loss in audio fidelity and quality, and in addition to being used in the Mp3 format, is also used in the majority of popular audio data reduction encoding systems, including the Advanced Audio Coding (AAC) format that is being promoted as an improved potential replacement for the Mp3 format.

In the case of a video recording, in a similar fashion the final format of the recorded video is selected and the master version of the video is decoded and re-encoded into the final format. In the case of the common Digital Video Disc (DVD) format the video component of the recording is encoded using the MPEG-2 video encoding standard, and the audio component is encoding using either the Dolby Digital AC-3 format, the Digital Theater System DTS format or the MPEG-1 Layer 2 format. These video and audio formats all use data compression methods similar in concept to the method described above in the case of the Mp3 audio file. In both the cases of audio and video, these compression methods cause the encoded audio and video files to have loss of accuracy and detail compared to the original audio and video content.

During the playback operation for an Mp3 file version of a recorded song, the audio portion of the file is first decoded from the Mp3 format using an Mp3 decoder that also re-encodes the audio signal into a 16 bit PCM format, typically with a sampling rate of 44.1 kHz. At that point a digital to analog (A/D) converter is then used to convert the encoded 16 bit PCM information into an electrical signal that is then used to drive the playback speakers or headphones via a preamplifier and power amplifier.

If the audio is a component of a combined audio/video media recording such as a DVD then the audio component is decoded using a similar process as described above with the appropriate decoder such as an AC-3 decoder.

The video component of a combined audio/video recording such as a DVD is decoded using a MPEG-2 video decoder and then when using the typical liquid crystal display (LCD) for viewing is converted into a series of analog electrical signals that quickly switch on and off the various colored pixels of the LCD to display the recorded video image.

It is clear that with these described audio, video and combined audio/video media recording, storage and playback systems that many stages of encoding, decoding and re-encoding are performed on both the audio and video components of the media files, and because of the well understood errors and limitations of these encoding systems, each of these stages introduce some loss of accuracy and fidelity in the audio and video recordings.

An additional operation used in audio recordings is the initial capture of audio sounds such as vocals and acoustic instruments such as a piano by using a microphone. The microphone uses a pressure sensitive surface to convert the audio sound pressure waves into an electrical signal, which as described above is then encoded into the initial multi-track recording format.

It is well known and understood that all microphone devices have some inaccuracies and thus do not create an electrical output signal that is an exact representation of the original audio pressure waves. In a similar fashion, the typical CCD video capture device has well known and understood inaccuracies that cause it to not create an electrical signal that is an exact representation of the original video light waves.

In addition the typical audio playback device also introduces inaccuracies and limitations in the final reconstructed audio sound. Economic considerations cause the typical audio playback system, for example a home stereo or portable Mp3 player, to have well known and understood limitations in both dynamic headroom and frequency response. In particular the limited dynamic headroom of audio playback systems causes distortion and lack of accuracy in the final audio sound wave, and also limits the usable audio output level of the system, as attempting to increase the output level past the maximum headroom level causes objectionable audio distortion.

Additional problems occur with the typical audio playback device when headphone or “ear bud” (small speakers that fit directly in the user's ears) are used, for example with portable media players such as the popular iPod players from Apple Computer Corp. In the audio recording system that has been described, in particular during the mastering process that has been described, most music recording are carefully adjusted during the mastering process for best listening results when using stereo speakers in a typical small room, such as a living room. The interaction of the sound coming out of the speakers and the room walls and contents will cause some reflected sound waves to reach the listeners in addition to the sound waves that come directly from the speakers to the user's ears. This additional reflected audio energy adds some ambience and depth to the music, making the listing experience more natural sounding and enjoyable, and this additional audio energy was expected by the audio engineer that performed the mastering of the recording.

When this recorded audio is then listened to using headphones or ear buds, the music will sound less lively as no reflected audio energy is present, and the sound is often described as sounding “inside my head” and somewhat dry sounding as opposed to the “inside the room” and somewhat lively sounding listening experience that was intended by the audio mastering engineer.

In a similar fashion the typical LCD video display device will have dynamic range and contrast limitations that cause the displayed video to not correctly represent the original video content and in addition to causing inaccuracies the display device can make the video content harder to discern and enjoy by the viewer.

An additional problem with the recording system that has been described is that the perceived audio output level of the final reconstructed audio sound wave in an audio or combined audio-video recording can vary highly from song to song. This is due to the fact that during the encoding process for the Mp3 file audio component of a combined audio/video recording that was described above, different recording and mastering engineers will use different equipment and use different systems to set the final average output level of the encoded audio at that point. This means the average perceived audio volume of a song recorded from one particular recording will often be very different from the perceived audio volume from a different recording.

Since today's music listeners are often using Mp3 based portable playback devices and often in a single listening session will listen to songs from a wide number of different albums and recording sessions, this means that the next song or audio-video file following the current song or audio-video file can be much louder or quieter, typically forcing the listener to manually adjust the playback volume for the best listening experience for many of the songs or audio-video files on their portable playback device.

In the case of viewing video or combined audio-video recordings from a variety of sources the overall brightness, color saturation and contrast can vary highly for different video recordings. This causes some videos to appear very bright, legible and colorful while other videos will be too dark and appear too colorless for satisfactory viewing.

Thus in the typical process of recording, storing and reconstructing songs, videos and combined audio-video media recordings, the multiple stages of capture, encoding, decoding, re-encoding and final reconstruction with a limited playback system all introduce additional errors and thus cause a loss of fidelity and accuracy in the final reconstructed audio sounds and video displays.

In the case where a data reducing encoding system such as the Mp3 audio encoding format or such as the MPEG-2 video encoding format is used, the introduced errors and associated losses of fidelity and accuracy are even more significant.

The variation in techniques and methods used by recording, mastering and production engineers managing these recording systems also create a large variation in the perceived volume and display qualities of different media recordings, requiring users to often make manual volume control and image setting changes for best listening and viewing. In addition the well understood headroom and frequency response limitations of typical audio playback systems and limited dynamic range and contrast of video display systems causes distortion and limits the maximum playback levels of the audio recordings and the accuracy and legibility of video recordings.

These described encoding and capture based errors, changes in audio volume and video display characteristics and limitations of the playback and display systems reduce the perceived audio and video playback quality and diminish the quality of the listening and viewing experience for the user.

A system that compensates for the encoding, de-coding and capture errors that have been described in the media recording process, eliminates the problem of audio volume and video characteristic changes for different media files and compensates for the limitations of typical audio playback and video display systems while improving the listening experience for headphone/ear bud years and while being fully compatible with the commonly used audio and video recording, storage and reconstruction systems described above is highly desirable.

In systems designed for the playback of audio CD's or Mp3 files or for the playback of the audio component of combined audio-video media files, simple audio equalizers or multi-band equalizers are often used to attempt to improve the audio fidelity and thus listening experience. Simple audio equalizers consist of a Bass and Treble control. The Bass control allows boosting or cutting the low frequency energy in the reconstructed audio signal, and the Treble control allows boosting or cutting the high frequency energy in the reconstructed audio signal.

Multi-band audio equalizers have multiple independently controlled adjustment bands that each control a separate audio frequency sub-range, with the bands spanning the range from low frequencies to high frequencies, often using 10 or more separate bands. Compared to the simple Bass and Treble equalizer, the multi-band equalizer provides more detailed control over the specific frequency ranges that are boosted or cut.

The equalizers are adjusted by the user to give the best possibility fidelity with a particular audio recording, and can be used to attempt to compensate for the audio system encoding, capture and playback errors that have been described.

To help with the problem of the perceived audio output level changes with different songs or combined audio/video media recordings, there are two methods that have been used in audio playback systems. The first method is called an Automatic Volume Control (AVC). An AVC device works by making a short term estimate of the past history of the audio level of a song. It then adjusts the current playback level of the song based on a comparison of that estimate to an internally set target volume level. For example, if the last few seconds of a particular song were loud compared to the target level, the AVC will adjust the current playback level to reduce the song volume. If the last few seconds of the song were quiet compared to the target level the AVC will adjust the current playback level to increase the song volume. AVC methods have been used to attempt to compensate for the described problem of level changes in various audio recordings.

The second method to help with the problem of the perceived audio output level changes with different songs or recordings has been used with the playback of Mp3 files. The popular personal computer (PC) Mp3 and AAC media player and manager software application called iTunes that was developed by the Apple Incorporated includes a “Volume Adjustment” setting that is accessible in the iTunes 8.2 version by using the following steps. With a song selected in the music library, select the “File” option in the main application menu. Then select the “Get Info” option, and in the dialog box that appears select the “Options” tab. At the top of the resulting dialog a “Volume Adjustment” control is available. The user may then adjust this control to change the desired playback volume of that particular song. The selected playback volume is then stored as an added parameter in the selected Mp3 or AAC format song. When that song is then played back, playback devices that are compatible with and can recognize this added parameter will then change the playback volume for that particular song to the level specified by the user. The user must then select every song in their library, and choose a playback level for that song.

In systems such as a television for the playback of video or combined audio/video recordings such as a DVD, to adjust video playback quality the systems will typically have controls that allow the user to adjust the overall image brightness and image contrast level. In addition some devices will have controls that allow adjustment of image “hue” and “saturation”. Hue adjustment rotates the range of colors being displayed. The saturation adjustment controls the intensity of each color.

In the case of attempting to use simple or multi-band audio equalizers to improve the playback of audio using the described recording and playback systems, there are two significant reasons why equalizers are not very effective in improving the audio quality. The first reason is that equalizers are only capable of boosting or cutting components that are already present in the audio signal.

However during the multiple stages of capturing, encoding, decoding and re-encoding the audio signal that have been described in a typical recording system, some details of the audio signal components are totally lost. For example, the human ear is very sensitive to the dynamic frequency harmonics that compose a typical musical note. Using a violin note as an example, as the musician articulates the performed note with a combination of finger vibrato and bowing techniques, an incredibly complex and harmonically related series of audio pressure waves occurs, which is then converted to a complex electrical signal by a microphone in the first step of the recording process.

Even the highest quality microphone will not fully accurately capture all the elements of this complex sound pressure wave, especially since some of the complex high frequency harmonics are much lower in level than the lower frequency harmonics, which makes it difficult for them to be recorded accurately. In addition during the multiple encoding, decoding, re-encoding and playback processes that have been described, due to the well understood errors of these processes there will be additional details of this complex waveform that will not be correctly represented. This inaccuracy becomes even larger when a data reduction based encoding method such as the Mp3 format is used.

As has been described, in order to reduce the number of bits required to store the audio recording, the Mp3 algorithm and the many other algorithms such as AAC that use similar methods use less precision on the relatively quieter parts of the encoded audio. In the example of the violin, this means that some of the lower level dynamic harmonics that are part of the note are either largely diminished and distorted in the encoded version or are not present at all. Even in the case where no data reduction method has been used, due to the errors in the multiple encoding, decoding and re-encoding steps that have been described, these upper harmonics can be largely distorted or missing in the reconstructed audio signal.

Attempting to use equalization to restore these missing harmonics has several significant limitations. If the original harmonic is mostly missing in the reconstructed signal, then using an equalizer to increase the gain in that frequency range will primarily only raise the level of the background noise in that frequency band, since the original harmonic is only minimally present. In addition, by raising the gain in this particular band with the equalizer you also raise the level of signals that are still correctly present in the reconstructed signal, but now these signals are much louder than they should be.

In the case of the violin note, this means that at best, using the equalizer is only partially effective in raising the level of the diminished harmonics for a particular note. But when a louder note is played that has significant amounts of energy in this frequency band, since the data reduction encoding method will now use higher accuracy for the louder signal in this band, the signal will not be diminished in the reconstructed signal. However since the gain in this band has been increased to compensate for the prior note, this current note will now sound too loud.

Adjusting an equalizer to compensate for missing or diminished frequency components in audio signal is thus of limited usefulness, as an adjustment for passages of music with notes in a certain frequency range can sound worse when the song contains notes in a different frequency range, and in addition the background noise present in the boosted frequency range will also be boosted.

An additional limitation of using equalization to attempt to improve the audio recording and playback system that has been described is that by using the equalizer to boost the gain in one or more ranges you have now created an audio signal that has higher average signal level. This is because when the equalizer boosts the gain in one or more ranges, that frequency component of the signal now has a higher amplitude level, and as this level is summed with the original signal, the combined signal will now have a higher overall amplitude level.

This higher level has the objectionable property of making the audio playback system more likely to distort the signal. This occurs because all audio playback systems have a limited amount of signal headroom before the system can no longer increase the sound wave level. At that point, instead of increasing the sound wave level, the system output stays at its maximum level, which is referred to as “clipping” the signal. Distortion from clipping is highly objectionable, and is a significant disadvantage to the use of equalizers to attempt to restore audio that has been reduced in quality through the audio recording and playback system that has been described.

One method to reduce the clipping that occurs from the use of equalization is to reduce the overall signal gain after the equalization has been increased in one or more frequency bands. However this reduction in overall gain then reduces the overall maximum output level of the system by that same amount. This is an additional significant disadvantage in using this approach.

To the user, the effect of missing musical harmonics due to the limitations of both the described system and the limited effectiveness of equalization is a significant one. The music sounds somewhat muffled and slightly dull, especially when in comparison to either the original actual performance or in comparison to a playback system that correctly represents all the audio harmonics.

Regarding the problem of volume level changes with different songs, the AVC system attempts to help this problem by making a short term estimate of the current song volume and then adjusting the song volume up or down to meet a target volume level. The problems with this method are well understood, since many songs have both loud and quiet segments, the AVC in operation partially turns down the loud segments and turns up the quiet segments. This reduces the dynamic range of the song, which often sounds artificial. In addition the user can often hear these gain changes as they occur, which is referred to as a “pumping” effect by audio engineers as the users hears the audio level “pumping” up and down.

Regarding the approach used by the iTunes player to place a parameter in the mp3 file to adjust the overall playback volume, this solution has the following limitations. This approach requires the user to manually select and set a playback level for each song, which is both time consuming and error prone. In addition, only the playback systems from Apple computer, such as the iPod portable audio player and the iTunes PC audio player can recognize and use this volume parameter, so when the file is used on one of the many mp3 audio playback systems from other manufacturers the volume problem is still present.

Below we will discuss the use and limitations of the video display brightness, contrast and color saturation controls that have been described.

The video brightness adjustment is useful in adjusting the overall image intensity to best suit the current viewing conditions. For example if the viewing room has bright lighting, making the display more difficult to view, and/or the video was recorded and encoded in a manner that caused it to be somewhat dark in appearance, turning up the brightness will help make the image more visible.

The video contrast control is useful in changing the how the video image spans the full range of fully dark components of the image to fully bright components of the image. Depending on how the video was recorded and encoded and/or depending on the display properties of the video monitor, which vary highly in their ability to accurately display a wide contrast range, images may appear “washed out” or “overly harsh”. A washed out image will typically not have enough variation in the dark parts of the image compared to the bright parts of the image. Turning up the contract in this case can help the quality of the display. A “harsh” image will have too much variation in the dark components of the image compared to the bright components, and in this case turning down the contrast can improve the image display.

As we have described, the video saturation adjustment controls the intensity of each color in the video images. Turning down the saturation drastically reduces the image to a pure black and white image. Turning the saturation up drastically tends to make the image over-colored and cartoonish appearing. Saturation adjustment has some value in adjusting image quality for best viewing, for example if the particular display monitor of a PC has somewhat flat coloration and/or the video was recorded and encoded in a manner that limited its color content, increasing the saturation of the video can make the image more appealing.

There are several limitations to the video controls described above. A serious limitation of all the controls is that they function independently. For example, the best image quality may require a careful adjustment of the brightness, contrast and saturation of the image. However, after adjusting the image saturation, a re-adjustment of the image brightness and contrast is often required. This requires the user to make a multi-step iterative process where first the brightness or saturation or contrast control is adjusted which then requires a re-adjustment of the other controls, and this process is repeated several times until the best image is present.

An additional serious limitation of the video controls described above is that the settings are fixed in value and do not compensate in any way for the properties of the video content being displayed. For example, the user may make a brightness adjustment for a particular video file that was recorded with poor lighting to make the video display more appealing on his particular display device. However if the next video being watched was professionally produced and contains brighter content it will appear too bright on the users display, requiring the user to then turn down the brightness for best display. This fixed value limitation applies to all the video controls described above, including brightness, saturation and contrast.

An additional limitation of both the audio and video controls described above is that they require independent adjustment. For example, the user must independently make adjustments to the audio processing for best sound quality and then make adjustments to the video controls for best video quality.

Another limitation is the ability to easily compare combined video and audio quality. A common method to evaluate changes in video and audio processing control settings is to have a processing “on/off” button that makes it easy to evaluate the audio or video without the control adjustments and with the control adjustments. With the audio and video controls described above it is necessary to independently turn on and off the video and audio processing to evaluate the effect of the combined audio and video processing.

### SUMMARY OF THE INVENTION

In accordance with the present invention, there is provided a media signal processing method that dramatically improves the perceived video and/or audio quality for most commonly used media recording, encoding, storage and playback systems. The method processes the video component of the media file in a manner that both improves the video display properties while also making the video images consistent in appearance when using media recordings from different sources. The method also synthesizes and boosts harmonics and spectral ranges that have been diminished or are missing in the audio component of media files and also processes the audio component to allow maximum playback level without distortion, while also insuring that the perceived playback level between different media files stays consistent. The method also improves the listening experience for users of headphone or ear buds.

It would be advantageous to provide a media processing method that enhanced the perceived quality of the audio component of a recorded media file.

It would also be advantageous to provide a media processing method that enhanced the perceived quality of the video component of a recorded media file.

It would also be advantageous to provide a media processing method that enhanced the recorded audio component by correcting for the errors and loss of fidelity that occurs due to the multiple encoding and decoding processes that occur in the audio component of recorded media files.

It would also be advantageous to provide a media processing method that enhanced the recorded video component by correcting for the errors and loss of fidelity that occurs due to the multiple encoding and decoding processes that occur in the video component of recorded media files.

It would further be advantageous to provide a media processing method that enhanced the recorded audio component by correcting for the errors and loss of fidelity that occurs when the recording and encoding process includes data reduction methods.

It would further be advantageous to provide a media processing method that provides the headphone and ear bud user with the perception of a natural acoustic space listening experience.

It would further be advantageous to provide a media processing method that enhanced the recorded video component by correcting for the errors and loss of fidelity that occurs when the recording and encoding process includes data reduction methods.

It would still further be advantageous to provide a media processing method that corrects for the difference in perceived audio output level that is caused by the differences in mastering and production methods of recordings from multiple sources.

It would still further be advantageous to provide a media processing method that corrects for the difference in perceived video brightness, contrast and saturation level that is caused by the differences in mastering and production methods of recordings from multiple sources.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a top level block diagram of the media enhancement method;

FIG. 2 is a block diagram of the audio processing components of media processor 17;

FIG. 3 is a block diagram of the video processing components of media processor 17; and

FIG. 4 is a block diagram of the enhancment system using direct playback.

For purposes of clarity and brevity, like elements and components will bear the same designations and numbering throughout the Figures.

### DESCRIPTION OF THE PREFERRED EMBODIMENT

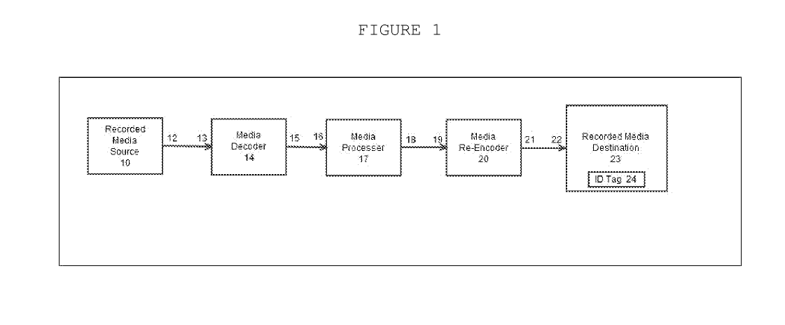

FIG. 1 is a top level block diagram of the media enhancement method. The recorded media source 10 element of FIG. 1 represents access to the encoded binary information of a recorded media file which may be a video file, an audio file or a combined audio-video file. The recorded media file thus could be an Mp3 audio file, an audio track on a compact disc (CD), a Digital Video Disc (DVD) or any other data object that contains binary information that represents a recorded media track. The recorded media source 10 element supplies this encoded binary information on its output 12 to input 13 of the media decoder 14 element.

An additional function of the recorded media source 10 element is to check to see if the recorded media file has already been enhanced by this method. If it has already been enhanced then an additional enhancement step is not needed or desired as enhancing a recorded media file more than one time can cause a reduction in quality. The check for prior enhancement is performed by looking for the presence of an id tag 24 element in the recorded media file. If this id tag 24 element is not present then the media enhancement processing is performed but if the id tag 24 element is present the system is signaled not to perform the enhancement processing.

Further details of how the id tag 24 element is embedded by the recorded media destination 23 element and detected by the recorded media source 10 element are shown below in the discussion of the recorded media destination 23 element.

The media decoder 14 element of FIG. 1 represents the processing implementation and system required to decode the encoded binary information connected to its input 13 and to create a temporary internal version of the decoded media recording. In the case where the recorded media source 10 represents an audio file an audio decoder is used. In the case where the recorded media source 10 is a video file a video decoder is used. In the case where the recorded media source 10 represents a combined audio-video file such as a DVD, an audio decoder is used to decode the audio component of the file and a video decoder is used to decode the video component of the file.

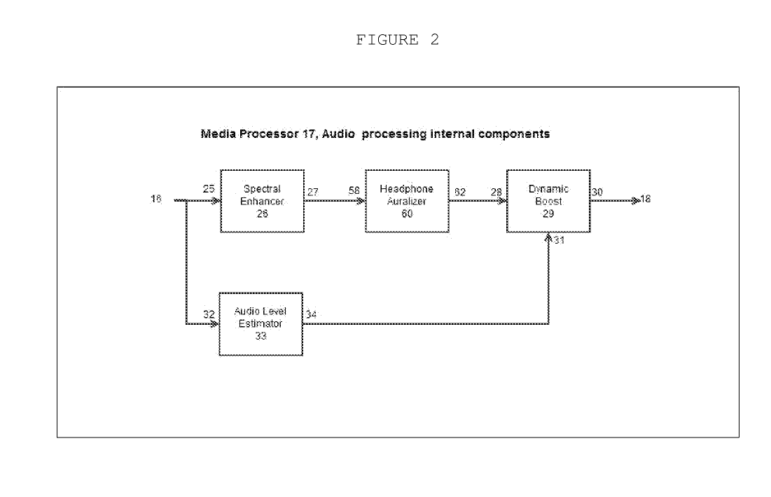

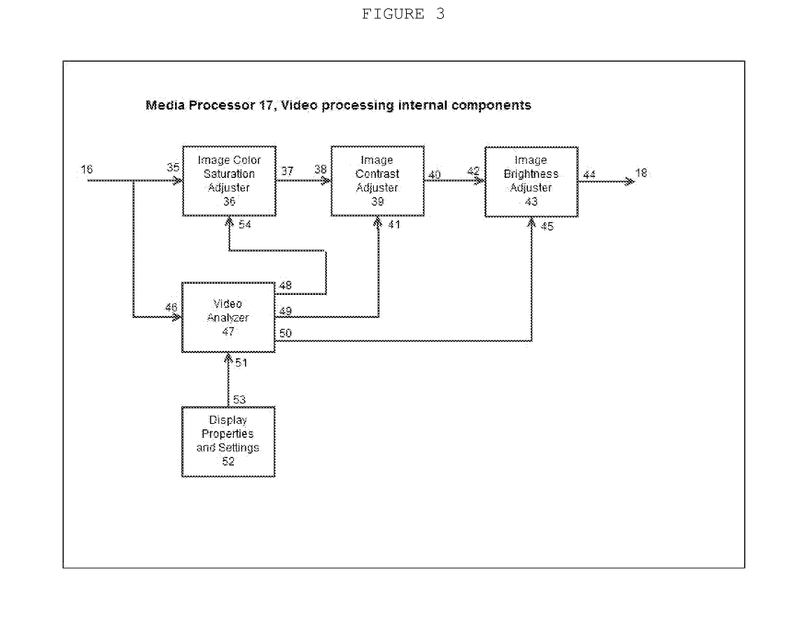

Note that as shown in FIGS. 2 and 3, the processing shown in the media processor 17 element of FIG. 1 is implemented using separate processing chains for the video and audio components. These separate processing chains begin after the decoding performed by the media decoder 14 and then re-combine the audio and video components at the media re-encoder 20 element of FIG. 1. As the audio and video processing chains are separate, we will first describe the audio processing chain below and follow that with the description of the video processing chain.

In the case where the recorded media source 10 element represents an audio mp3 file or represents a combined audio-video file with the mp3 encoding method used on the audio component, the audio decoding implementation of the media decoder 14 can be one of the many commercially available MPEG-1 Layer 3 mp3 decoders that were originally developed by the Fraunhofer Society and are currently licensed by the Thomson Corporation that can be contacted at www.mp3licensing.com <http://www.mp3licensing.com>.

The decoded temporary internal version created in the audio decoder function of the media decoder 14 is a sequential list of the time series of decoded values that represent the recorded audio. The preferred format for this temporary internal version of the decoded audio is to use a 32 bit signed floating point value with a 24 bit mantissa and 8 bit exponent to represent each time series value, with the audio signal values ranging from −1.0 to 1.0.

In the case where the recorded media source 10 is a typical stereo 44.1 khz sampling rate mp3 file and for the purposes of this example if that file contains a song exactly 3 minutes long, the temporary internal version created from the encoded audio consists of a list of sample points as follows:

1st left channel 32 bit value, 1st right channel 32 bit value, 2nd left channel value, 2nd right channel value, . . . (listing continues)

The total number of 32 bit values in the temporary internal version is thus:

$$Number of 32 bit values = 2 channels \times \text{44,100} samples / sec \times 3 minutes \times 60 secs / min = \text{15,876,000} 32 bit time series values$$

The audio decoder component of the media decoder 14 element can be implemented using well known methods using disc memory or flash memory or random access (RAM) memory to store the temporary internal decoded values so that the elements connected to its output 15 can independently request to sequentially receive the entire list of the temporary internal values when required. As we will seen in further detail, this will allow the audio level estimator 33 element of FIG. 2 to initially request and process the entire list of temporary internal values so as to perform the audio level estimate prior to the processing operations of the temporary internal values that are performed by the spectral enhancer 26, headphone auralizer 60 and dynamic boost 29 elements. Note than a well known and understood alternative implementation of the audio decoder that also functions with this system would be to implement the decoder so that instead of storing the entire history of time series points, the time points are supplied on request to the audio level estimator 33 and spectral enhancer 26 elements in sequential batches that are typically referred to as buffers. For example if the buffer size is set to 4 time series values, then the first buffer passed to the audio level estimator 33 would be:

(1st left channel 32 bit value, 1st right channel 32 bit value, 2nd left channel value, 2nd right channel value)

After accepting and processing that buffer, the audio level estimator 33 block would then request and receive the next buffer:

(3rd left channel 32 bit value, 3rd right channel 32 bit value, 4th left channel value, 4th right channel value)

This passing and processing of buffers is then continued between the audio decoder component of the media decoder 14 and the audio level estimator 33 elements until all 15,876,000 time series values have been processed by the audio level estimator 33 element so as to calculate the audio level estimate.

Depending on the manner in which this audio enhancement system is implemented there typically will be advantages in cost effectiveness in choosing either the full list of temporary internal values or the buffered approach to implement the system. However, with either of these implementation methods it is well known and understood by those experienced in audio processing system design that the processed audio component of the resulting recorded media destination 23 object will be exactly the same regardless of which of these two implementation methods is used. For that reason in the following description we will describe the functionality of the system as though the full list of internal temporary values method of implementation has been used, but it is straightforward to also exactly implement the described processing using a buffer passing approach, and this is the case for both the audio enhancement system and the video enhancement system that is described below.

After the recorded media source 10 has been decoded into a temporary internal version by the audio decoder component of the media decoder 14, prior to any additional processing by other elements the audio level estimator 33 of FIG. 2 accesses the full list of temporary internal values through its input 32 via input media processor 17 input 16 in order to perform an averaged estimate of the audio volume level of the temporary internal version. There are many well known methods that can be implemented in the system for performing a suitable audio volume level estimate. The preferred implementation is shown in the pseudo-code source listing in the table below, where the variable RmsLevel contains the estimate of the audio volume level. In the system this pseudo-code would be executed on a microcontroller, microprocessor or the general purpose processor of a PC. It is also straightforward to implement the processing described in the pseudo-code listing with a dedicated hardware system that can be constructed from general purpose logic elements or with an FPGA or ASIC implementation approach.

```
    Set NumSamples to the total number of audio signal point
values in the media file
    Initialize the RmsLevel estimate to zero
    Initialize the SampleIndex count to 1
    WHILE SampleIndex <= NumSamples
      RmsLevel = RmsLevel + AudioSignalValue[SampleIndex] *
AudioSignalValue[SampleIndex]
      SampleIndex = SampleIndex + 1
    ENDWHILE
    RmsLevel = SquareRoot(RmsLevel/NumSamples)
```

After the audio volume level estimate is performed, the estimated audio level shown as RmsLevel in the source listing above is then placed on output 34 of the audio level estimator 33 so that the level estimate is available at input 31 of the dynamic boost 29 element. Prior to any processing occurring by the spectral enhancer 26, headphone auralizer 60 and dynamic boost 29 elements, on completion of the level estimate by the audio level estimator 33, the dynamic boost 29 element reads the audio level estimate on its input pin 31. This audio level estimate is then used to calculate an audio level gain setting to be used by the dynamic boost 29 element as shown in the source code listing in the table below. Note that the estimated audio level RmsLevel is used to calculate the final gain value shown as boost that will be used as will be described in the dynamic boost 29 element.

As shown in the pseudo-code listing in the table below the parameter value PROCESS_WAV_RMS_NORMALIZATION_FACTOR is used in the calculation of the boost final gain setting for the recorded audio and for audio signal values in the preferred range of from −1.0 to 1.0 the preferred setting of the PROCESS_WAV_RMS_NORMALIZATION_FACTOR parameter is 0.2. The preferred value for the parameter PROCESS_WAV_RMS_NORMALIZATION_MAX_BOOST shown in the source listing below is 10.0. This parameter sets the maximum audio level boost that can be applied to the recorded audio output.

As has been described, a significant issue to users of iPod and similar type devices is the large variation in average audio output level of songs undergoing playback. The audio level estimator 33 element of FIG. 2 in conjunction with the dynamic boost 29 element solve this issue by causing the average output level of the audio file components created by the recorded media destination 23 element to be very close in value. This is implemented by using the gain estimate generated on output 34 of the audio level estimator 33 and transmitted to input 31 of the dynamic boost 29 to scale in an inverse fashion the gain control setting of the dynamic boost 29 element as shown in the table below, causing the final average gain of the audio files created by the recorded media destination 23 element to be very similar.

```
    Initialize boost to 1.0
    IF RmsLevel > 0.0
      boost = PROCESS_WAV_RMS_NORMALIZATION_FACTOR/
      RmsLevel
    ENDIF
    IF boost < 1.0
      boost = 1.0 (If boost is less than one, set it to one)
    ENDIF
    IF boost >
    PROCESS_WAV_RMS_NORMALIZATION_MAX_BOOST
    Boost =
    PROCESS_WAV_RMS_NORMALIZATION_MAX_BOOST
    ENDIF
    SetDynamicBoostDirect(boost) (Set the boost value in the
dynamic boost 29 element)
```

As the first step of its processing, the spectral enhancer 26 element of FIG. 2 improves the audio quality by synthesizing frequency content that is harmonically related to the audio waveforms contained in the temporary internal values. The synthesized frequency content helps compensate for the frequency content that has been lost or diminished during the many encoding and decoding operations that have been described in our previous overview of the typical audio recording process.

There are many commerically available systems that can implement this required function of generating and adding high frequency harmonics in the spectral enhancer 26 element. One such system is the Aural Exciter product available from Aphex Systems. This product uses methods directly derived from the methods originally described in U.S. Pat. No. 4,150,253 to synthesize additional harmonics that are added to the original audio. There are several additional commercially available systems for adding synthesized harmonics to audio that operate in a very similar fashion to the Aural Exciter product and can be used in the implementation of the spectral enhancer 26.

The preferred implementation for adding synthesized harmonics in the spectral enhancer 26 element is the Fidelity processing component of the DFX audio processing system available from the company Power Technology, www.power-t.com <http://www.power-t.com>. This component synthesizes high frequency harmonics of a very musical and high quality and can be licensed and implemented using a C++ DFX software development system (DFX SDK). Further details of implementing the spectral enhancer 26 element will be shown later in this document.

As the second step of the processing performed by the spectral enhancer 26, the audio signal values that have first been processed by the DFX Fidelity component to synthesize high frequency harmonics are then processed to increase their bass frequency energy content. This increase in bass frequency energy content improves the audio quality by helping to restore the loss of low frequency content that has been lost or diminished during the many encoding and decoding operations that have been described in our previous overview of the typical audio recording process.

There are several well known systems and commerically available products that can be used in the spectral enhancer 26 to implement the function of increasing the bass frequency energy content. One approach is to use one of the many well understood audio equalization methods to implement a low frequency boosting system that raises the energy level of the existing bass frequency content in the audio signal.

An alternative approach is to use one of the commerically available methods that synthesize additional bass frequency energy from the existing audio signal information, such as the TruBass technology available from the SRS Labs company to implement the bass increasing operation in the spectral enhancer 26.

The preferred implementation to increase the low frequency component of the audio signal in the spectral enhancer 26 element is the Hyperbass bass boost processing component of the DFX audio processing system available from the company Power Technology, www.power-t.com <http://www.power-t.com>. This system has the advantage of increasing the bass frequency content without causing any undesirable distortion in the audio as can be caused with methods such as the TruBass system. This component can be licensed and implemented using a C++ DFX software development system (DFX SDK). Further details of implementing the spectral enhancer 26 element will be shown later in this document.

The bass frequency energy boosting is performed on the audio signal values that have already been processed in the spectral enhancer 26 with the DFX Fidelity component that adds high frequency spectral content to the audio signal. After the bass boosting processing has been performed the audio signal is then passed to output 27 of the spectral enhancer 26 to allow the audio to then be processed by the headphone auralizer 60 element at its input 58.

The headphone auralizer 60 element of FIG. 2 processes the audio signal in a manner so that when using headphones or ear buds the listener perceives that instead of having the typical “inside the head” listening experience that occurs with headphones or ear buds, the listener perceives an experience of listening to the audio in a very natural sounding acoustic space such as a perfectly constructed listening room that supplements the direct sound to the users ears with reflections from the rooms walls and elements that add a very natural sounding warmth to the music and sound.

This includes the user perceiving that some sound energy is coming from directions both behind, to the left and right and in all directions around the user as would occur with music being played in a natural acoustic space.

The headphone auralizer 60 element also includes the ability to give the listener the experience of the widely used 5.1 and 7.1 surround sound systems while using headphones or ear buds, making the system suitable for the audio processing system in a movie or DVD listening system. In this case the headphone auralizer 60 element properly represents at the correct listening locations the various sound channels used in 5.1 and 7.1 surround sound systems.

The headphone auralizer 60 element implements its processing by using the well understood concept of auralization. Auralization makes use of two models, an acoustic space model and the Head Related Transfer Function (HRTF) model. The HRTF models how sound waves are affected as they strike the listeners head, face, shoulders and impinge from various directions on the listeners ears. The HRTF model is very important in making a headphone and ear bud user perceive that they are listening to audio in a actual acoustic space as opposed to listening with headphones or ear buds.

The methods to create HTRF models are well known and understood. An effective way to create a HRTF model is to purchase commercially available dummy heads that include very accurate microphones placed in the ears of the dummy head. Placing this head in an anechoic chamber then allows the use of sound sources and well understood analysis methods to create the HRTF model. This method of measuring and recording sound using dummy heads is also referred to as binaural recording.

The acoustic space model provides a method of generating the model for how the sound is affected by having the sound sources being located in an acoustic space with the listeners ears at a different location in the space. Given a location for the listener, the sound source locations, the acoustic space size, shape and wall material, the model then provides a method to process an audio source so that the resulting two channels of sound (left ear and right ear) closely approximate the sound that would be achieved at the users ear locations in the actual acoustic space with those sound sources. The methods used to create acoustic space models are well known and understood. Acoustic space models can be created using both purely analytic models that mathematically model how the sound reflects off the various room surfaces before reaching the listening location and by methods that measure the actual response of a real room.

The HRTF and acoustic room modeling methods described above are well known and understood and are described in detail in references such as the internet web site located at:

http://empac.rpi.edu/media/auralization/ambisonics.html

The acoustic room model is then combined with the HRTF model to implement the headphone auralizer 60 element. The headphone auralization element supports audio signals at its input 58 with one channel (mono), two channels (stereo) or six and eight surround sound channels. The headphone auralization element then processes the audio input channels to create two output channels at its output 62, a left ear output and a right ear output. When the system of FIG. 1 is then used with headphones or ear buds, the headphone auralization element then gives the user of the system the perception that the music or sound is being listened to in the acoustic space being modeled by the headphone auralizer 60 element. Thus even though only 2 channels are required for the storage and playback of the left ear and right ear signals, the headphone auralizer 60 element provides the user with the perception of listening to 6 or 8 surround sound channels when listening to audio in surround sound format. The headphone auralizer 60 element can contain acoustic space models for many different acoustic environments so the user can select to hear his music as it would sound in a large concert hall or in a small music listening chamber as well as many other acoustic spaces.

A commercially available system that can be used in the system of FIG. 2 for supplying the headphone auralization element is the Dolby Headphone processing system available from Dolby Laboratories, with offices in San Francisco, Calif. The preferred method for the headphone auralization element is the Headphone Mode component of the DFX audio processing system available through license of the DFX SDK from the company Power Technology, www.power-t.com <http://www.power-t.com>.

In summary, the headphone auralizer 60 element of FIG. 2 takes the mono, stereo or surround sound audio signal on its input 58 from output 27 of the spectral enhancer 26 element and processes the audio signal so that it will give the perception the of the headphone or ear bud listener being located in a particular acoustic listening environment and then outputs those processed left ear and right ear channel outputs on its output 62, which is connected to input 28 of the dynamic boost 29 element.

An advantage of the dynamic boost 29 element in conjunction with the headphone auralizer 60 element is that the dynamic boost 29 element processes the audio signal so that the extra signal energy added by the spectral enhancer 26 element and the headphone auralizer 60 element do not cause clipping of the audio signal or require that its volume level be reduced.

The dynamic boost 29 element of FIG. 2 processes the audio signal in a manner that allows a higher perceived audio output level without causing audio clipping or distortion. Providing the highest perceived audio output level given the headroom limitations of a particular audio playback device is very advantageous as it allows audio systems with limited size and power such as portable audio/mp3 players, portable DVD players, laptop computers, cell phones and smaller audio speakers to provide high audio output level and quality in a small size and weight.

In addition to processing the audio in a manner that allows a high perceived audio output level, the dynamic boost 29 in a similar fashion processes the audio so that the extra audio energy added to the signal by the spectral enhancer 26 and headphone auralizer 60 elements do not cause distortion of the audio signal.

The final function of the dynamic boost 29 element is to use the audio level estimate value provided at its input 31 to set the average average audio level of the audio signal at its output 30 to the desired audio level.

As the first step in the processing performed by the dynamic boost 29 element, the element reads the audio level estimate provided on its input 31 that has been supplied by the audio level estimator 33 element. As has been described the audio level estimator 33 generates this level estimate by making a first complete processing pass on all of the recorded audio data before any audio processing has been performed by the spectral enhancer 26 and dynamic boost 29 elements.

When the audio level estimate is made available on input 31 of the dynamic boost 29 element, the dynamic boost 29 element stores this value to use to calculate as has been described above the multiplicative gain factor on the audio signal that it processes.

There are many commercially available systems that can be used in the dynamic boost 29 element to implement the processing of the audio signal so that a higher output level is perceived in without causing distortion. The well known and straightforward to implement system that is called an audio compressor can be used for this function, although this method is also well known to cause undesirable audible “pumping” and loss of dynamic range in the processed audio. An example of an implemention of this method of processing is the dbx Model 160a stereo compressor manufactured by the dbx Professional Products company.

Another well known and understood system that can be used in the dynamic boost 29 element to implement the processing of the audio signal so that a higher output level is perceived without causing distortion is called a multi-band compressor. This is system that separates the audio signal into a number of individual frequency bands and then applies a separate audio compression operation on each frequency band. While this system can be more effective than a simple audio compressor, it can still exhibit the undesirable properties of causing audible pumping and loss of dynamic range in the processed audio signal.

In the preferred embodiment the dynamic boost 29 element processes the audio to allow a high output level without causing distortion by using the audio operation commonly described with the name “look ahead peak limiter”. This operation uses an internal buffer to continously “look ahead” at a short time segment of the audio signal so that the audio signal gain can be gradually reduced when it appears that the audio signal is increasing quickly and could potentially cause clipping and distortion. There are many commercially available implementations of an audio look ahead peak limiter that can be used to implement this functionality in the dynamic boost 29 element, for example the L1 UltraMaximizer Peak Limiter available from the Waves Audio Ltd. Company.

The preferred embodiment of the look ahead peak limiter implementation of the dynamic boost 29 element is the Dynamic Boost 29 processing component of the DFX audio processing system available from the company Power Technology, www.power-t.com <http://www.power-t.com>. This implementation has the advantage of allowing a high output level in the processed audio while not causing audio pumping, distortion or clipping of the audio signal. This component can be licensed and implemented using a C++ DFX software development system (DFX SDK). Further details of implementing the dynamic boost 29 element using the DFX SDK are shown below.

With all of the described dynamic boost 29 implementations to process of the audio signal so that a higher output level is perceived without causing distortion, the parameter described earlier named boost is used as was calculated to specify the overall audio signal gain setting of the applied processing. With the preferred embodiment the use of this gain setting was described in detail above. With embodiments using other commercial implementations for the dynamic boost 29 element the calculated boost value is used to directly set the overall signal gain of the processing implementation, which is a common and well understood control parameter for all these commercial implementations.

The C++ source code listing in the table below shows the preferred implementation of the spectral enhancer 26, headphone auralizer 60 and dynamic boost 29 elements using the DFX SDK from Power Technology. In the system this C++ code would be executed on a microcontroller, microprocessor or the general purpose processor of a PC. It is also straightforward to implement the processing implemented in the DFX SDK with a dedicated hardware system that can be constructed from general purpose logic elements or with an FPGA or ASIC based implementation approach.

The section in the table labeled Initialization sets the correct preferred parameter settings for the DFX SDK processing. Note that the gain parameter boost that was calculated as shown above is used in the initialization call below to correctly set the gain function used by the dynamic boost 29 element.

The C++ source code in the table below is used in the following manner to implement the functionality of the spectral enhancer 26, headphone auralizer 60 and dynamic boost 29 elements using the DFX SDK. Prior to processing any audio the Initialization functions are first called to correctly set the processing parameters to the preferred values shown.

After the audio level estimate has been performed and is available at input 31 of the dynamic boost 29 element of FIG. 2, that input value sets the boost value used in the DFX SDK initialization call below, along with the other Initialization functions that are called to correctly set the processing parameters to the preferred values shown.

The spectral enhancer 26 element then reads the audio signal from the audio decoder component of the media decoder 14 element at its input 25 via input media processor 17 input 16. In the source code listing in the table below this is shown as the input.Read call. The audio data in the input_buf buffer is then passed into the DFX SDK processing function DfxSdkObj.ProcessSamples. In this call the variable PROCESS_WAV_SAMPLE_SET_BUFFER_LENGTH is set to the number of audio sample points contained in the input_buf buffer.

This function call first implements the high frequency synthesis operation of the spectral enhancer 26 by processing the passed in buffer using the DFX SDK Fidelity function and then implements the low frequency energy boost component of the spectral enhancer 26 by processing the passed in buffer using the DFX SDK Hyperbass function. At this point processed buffer then represents output 27 of the spectral enhancer 26. The DFX SDK then processes the buffer to implement the DFX Headphone Mode, thus representing output 62 of the headphone auralizer 60. The function call then processes the buffer using the DFX SDK Dynamic Boost 29 function, including the boost gain set by the initialization call above, to create a processed output buffer that represents output 30 of the dynamic boost 29 element, to be next processed by the audio re-encoder component of the media re-encoder 20 element. The operation of passing the audio signal now processed by the DFX SDK from output 30 of the dynamic boost 29 element and thus from output 18 of the media processor 17 to input 19 of the media re-encoder 20 element is shown in the source code listing as the output.Write(output_buf) call.

| // Initialization - Set DFX SDK parameters to preferred | |
|---|---|
| settings | |
| DfxSdkObj.SetBassBoost(0.53); | // Sets bass boost amount |
| DfxSdkObj.SetFidelityBoost(0.4); | // Sets high frequency |

```
synthesis
    // Turn on Headphone Auralization Mode
    SetHeadphoneMode(true); // true turns headphone mode on
    // Initialization - set dynamic boost 29 element control
values
    // Call below sets gain derived from audio level estimator
33 element
    DfxSdkObj.SetDynamicBoostDirect(boost);
    // Read signal from input 25 into internal buffer
    input.Read(input_buf);
    // Perform spectral enhancer 26, headphone auralizer 60 and
dynamic boost 29 processing.
    DfxSdkObj.ProcessSamples(input_buf, output_buf,
PROCESS_WAV_SAMPLE_SET_BUFFER_LENGTH);
    // Place processed audio in output buffer and dynamic boost
29 output 30
    output.Write(output_buf);
```

The audio re-encoder component of the media re-encoder 20 element of FIG. 1 accepts on its input 19 the audio signal that has been originated from the recorded media source 10 element, has been decoded by the audio decoder component of the media decoder 14 element, has had an audio level estimate performed by the audio level level estimator, and using the level estimate that was created prior to any processing having occurred with the spectral enhancer 26 and dynamic boost 29 elements, was then processed as has been described by the spectral enhancer 26, headphone auralizer 60 and dynamic boost 29 elements. This processed audio signal is then used as input 19 of the audio re-encoder component of the media re-encoder 20 element.

The audio re-encoder component of the media re-encoder 20 element uses an implementation of the audio encoding method required to generate the desired format of the audio component of the recorded media destination 23 element. For example, if the format of the recorded media destination 23 is to be an mp3 format audio file that will be placed for playback on a portable audio player such as the popular iPod audio player available from Apple Computer, then the encoder implemented in the audio re-encoder element is one of the many commercially available MPEG-1 Layer 3 mp3 encoders that were originally developed by the Fraunhofer Society and are currently licensed by the Thomson Corporation that can be contacted at www.mp3licensing.com <http://www.mp3licensing.com>.

If the format of the recorded media destination 23 is to be a DVD file that will be used for playback on a DVD player, then the encoder implemented in the audio re-encoder component of the media re-encoder 20 element is typically the MPEG-1 Layer 2 audio format.

If the format of the recorded media destination 23 is to be an AAC (Advanced Audio Coding) format audio file that will be placed for playback on a portable audio player, then an AAC encoder is implemented in the audio re-encoder component of the media re-encoder 20. In a similar fashion, for any other desired re-encoding formats such as Microsoft's .wma or .wav formats the required encoder is implemented in the audio re-encoder component of the media re-encoder 20 element.

If the format of the recorded media destination 23 is to be a track on a compact disc (CD), the well understood and straightforward 16 bit PCM encoding process is implemented in the audio re-encoder component of the media re-encoder 20 element, and for best performance the encoder will employ one of the many well understood methods for applying dithering on the PCM signal values.

As has been described, the audio encoding process can be implemented either by passing buffers of audio signal values to input 19 of the media re-encoder 20 and then passing the encoded information to its output 21 or the temporary internal list method can be used so that the entire list of audio signal values is passed into input 19 of the media re-encoder 20 with the entire encoded output then made available at output 21 of the media re-encoder 20.

In the preferred embodiment of the audio re-encoder component of the media re-encoder 20 element, encoding quality of the re-encoded audio component at output 21 is higher than the encoding quality used on the original audio signal component from the recorded media source 10 element. The increase in encoding quality for re-encoded audio component can be achieved by using a higher quality encoding process with the same bit rate as the media source file, or by using the same encoding method but with a higher bit rate for the re-encoded audio component or by using both methods to increase the quality of the re-encoded audio component.

For example, if recorded media source 10 is an mp3 file with a binary bit rate of 128 kbps, then one approach to improve the quality of the re-encoded audio component is to use an encoding bit rate of the audio re-encoder component of the media re-encoder 20 that is higher, for example 256 kbs. The higher accuracy of the higher bit rate of the audio re-encoder component of the media re-encoder 20 allows a more accurate representation in the recorded media destination 23 audio object component of the added spectral content that has been added by the spectral enhancer 26 and dynamic boost 29 elements. However, while the use of a higher bit rate for the audio re-encoder is preferred, in some implementation cases this higher rate will not be available or practical, and in this case there will still be a substantial increase in audio quality through the use of the system in this case where the bit rate of the audio components of the recorded media source 10 and the recorded media destination 23 are the same.

Another method to improve the audio quality of the system of FIG. 1 is to use an audio re-encoding method that yields higher overall audio quality than the encoding method that was originally used to create the audio component of the recorded media source 10. For example if an mp3 encoder was used to create the original recorded media source 10 of FIG. 1, an AAC encoder can be used to implement the audio re-encoder component of the media re-encoder 20 element. As the AAC encoding method has improved technology that yields better audio quality while using the same audio data bit rate this will improve the quality of the audio component of the enhancement system of FIG. 1 by more accurately encoding the added spectral energy generated by the spectral enhancer 26 element of FIG. 2.

This improvement occurs both in the case where the same audio data bit rate is used for the audio component of the recorded media source 10 and media re-encoder elements and in the case described above where the audio data bit rate of the audio component of the re-encoder element is higher than that of the audio component of the media decoder 14 element.

In some implementations the use of variable bit rate (VBR) decoders and encoders in the audio decoder and audio re-encoder components will be advantageous. VBR encoders make more efficient use of bit rate and storage space by employing higher bit rates on more complex segments of the audio signal and lower bit rates on less complex segments of the audio signal. The audio enhancement component of the system of FIG. 1 works equally well when implemented with either fixed rate or VBR decoders and/or encoders.

The recorded media destination 23 element of FIG. 1 represents the operation of assembling the final stored output object of the media enhancement process shown in FIG. 1. The recorded media destination 23 element accepts on its input 22 the encoded audio signal that has been generated by the audio re-encoder component of the media re-encoder 20, and this forms the audio component of the recorded media destination 23 element. The recorded media destination 23 element assembles the entire audio signal communicated to its input 22 by the audio component of the media re-encoder 20 into the final recorded media destination 23 object.

In the case where the result of the media enhancement system of FIG. 1 is to be an mp3 file for playback on a portable audio player such as the iPod product available from Apple computer then the Recorded media destination 23 represents an mp3 file that has been prepared by the system so that it can be installed on the iPod player for playback by the user. To create this mp3 file the recorded media destination 23 element accepts the encoded audio signal on input 22 and using well understood methods writes this information into a binary disc file following the publically available mp3 format file storage specifications. In a similar fashion when the recorded media destination 23 is to be in other formats such as the AAC format or Microsoft's .wma or .wav formats the element writes the information to a binary disc file using the appropriate publically available specifications for those formats.

When the recorded media source 10 element of FIG. 1 includes a video component, the video processing internals of the media processor 17 are used to process and enhance the video component as shown in FIG. 3. When the recorded media source 10 contains a video component it places the video component on output 12, and the media decoder 14 accesses this video component on its input 13. The media decoder 14 then applies the correct video decoding operation depending on the format of the video component. For example if the recorded media source 10 is a DVD then the video will be encoded using the MPEG-2 video encoding standard, and an MPEG-2 decoder is then implemented in the media decoder 14.

As has been described earlier, the media decoder 14 element of FIG. 1 represents the processing implementation and system required to decode the encoded binary information connected to its input 13 and to create a temporary internal version of the decoded media recording. In a similar manner to the temporary internal version that was created for the audio component, the temporary internal version of the video component is a sequential list of decoded numeric values that represent the recorded video component. There are a variety of video representations that can be used to implement the video processing of FIG. 3, but the well known and understood “RGB” and “YUV” methods are the most common methods that can be used in the implementation. With these well known and understood methods, the video is represented as a series of image frames, typically with a frame rate ranging from 24 to 30 frames per second. Each image frame consists of a 2 dimensional array of individual image “pixel” values, with the typical frame sizes of 320×240, 640×480 and larger, with the larger frames providing more resolution and accuracy in the displayed image.

Each image pixel value either directly (YUV and similar formats) or indirectly (RGB and similar formats) contains numerical values for its “luminence” (brightness) and “chrominance” (color). In the YUV representation the image brightness and color are encoded directly while in the RGB method the brightness and color are encoded by setting separate levels for the Red, Blue and Green components of the pixel value.

In the following description the YUV method will be used in the described implementation, but the described image enhancement system can implemented in a straightforward manner using the RGB method and all other image encoding methods.

The decoded temporary internal version created in the video decoder component of the media decoder 14 is a sequential list of the pixel by pixel series of decoded values that represent each image frame in the recorded video. The preferred format for this temporary internal version of the decoded video is to use a 32 bit signed floating point value with a 24 bit mantissa and 8 bit exponent to represent each pixel component value, for example each RGB component of the pixel, with the pixel component values ranging from 0.0 to 1.0, so that a value of 1.0 for the “Red” component of an RGB pixel means the red component is fully on, while a value of 0.0 means the red component is fully off.

When the recorded media source 10 element of FIG. 1 contains a video component, input 16 of the media processor 17 then distributes the video component to input 35 of the image color saturation adjuster 36 element of FIG. 3 and to input 46 of the video analyzer 47 element of FIG. 3. The video analyzer 47 element then by using outputs 48, 49 and 50 can make adjustments to the image color saturation adjuster 36 element through its input 54, the image contrast adjuster 39 element through its input 41 and the image brightness adjuster 43 element through its input 45. The video signal that was supplied on input 16 of FIG. 1 is then adjusted for the properties of image color saturation, image contrast and image brightness with the modified video signal then being placed on output 18 of FIG. 1.

The video analyzer 47 element can implement a variety of methods to to improve the quality of the video signal processed by FIG. 3. In these methods the video analyzer 47 analyzes properties of the video signal supplied to its input 46. This analysis can be performed in a variety of different methods. One method is to base the analysis on the pixel values of each current frame of the video signal. With this implementation the video image frame is read into input 46 of the video analyzer 47 element and the values of that particular frame of pixels are used to determine the best settings for the image color saturation adjuster 36, image contrast adjuster 39 and image brightness adjuster 43 elements of FIG. 3. As will be described later, this method is appropriate when the recorded media source 10 element represents a streaming audio-video file.

An alternative method is to use the pixel values from the current video image frame in addition to the pixel values from one, more than one or all of the video image frames present in the video component to determine the best settings for outputs 48, 49 and 50. For example, if the video has a frame rate of 30 frames per second and starts at time zero and has a total length of 20 seconds there will be 600 image frames of pixels in the temporary internal version of the video signal that as was described above is made available at input 16 by the media decoder 14 element. All those frames of pixel values can then be used by the video analyzer 47 to best determine the settings for the color saturation, image contrast adjuster 39 and image brightness adjuster 43 elements.

Those calculated settings are then set from output 48 of the video analyzer 47 to input 54 of the image color saturation adjuster 36 element, from output 49 of the video analyzer 47 to input 41 of the image contrast adjuster 39 element and from output 50 of the video analyzer 47 to input 45 of the image brightness adjuster 43 element.

An additional set of information input into the video analyzer 47 element is shown in the display properties and settings 52 element of FIG. 3. This element contains information that the user may set about the current type of video display in usage. For example, the display could be of the LCD, Plasma or LCD-LED type. As these displays all have different color, contrast and brightness capabilities and characteristics, supplying this information to input 51 of the video analyzer 47 from output 53 of the display properties and settings 52 element allows the video analyzer 47 to make the best possible settings of its outputs 48, 49 and 50 so as to provide best display quality with that particular display device.

The preferred method for implementing the video processing of FIG. 3 is shown in the C++ source code listing in the table below. In the system this C++ code would be executed on a microcontroller, microprocessor or the general purpose processor of a PC. It is also straightforward to implement the processing described in the C++ listing with a dedicated hardware system that can be constructed from general purpose logic elements or with an FPGA or ASIC implementation approach.

Note that the YUY2 video format referenced in the listing is a specific type of the general YUV video format. This example implements the video analyzer 47, image color saturation adjuster 36 and image brightness adjuster 43 elements of FIG. 3 in the listing. In this example the contrast of the modified image is modified through adjustments to the color saturation and brightness.

This method performs the function of the video analyzer 47 on the video image frame of pixels passed into the C++ function in the pixel frame variable named pbInputData, which represents the video signal passed in to input 16. Based on that analysis it modifies the color staturation values of the pixels thus implementing the image color saturation adjuster 36 element. It also modifies the brightness values of the pixels thus implementing the image brightness adjuster 43 element, and while in this example no direct modifcations are performed using the image contrast adjuster 39 element the image contrast is modified through the modifications of the image color saturation and brightness.

The modified frame of pixel values are placed in the pixel frame variable named pbOutputData, which represents the enhanced video image frame passed back out on output 18. In the code listing below, the typical setting for the control variable f_YUV_brightness is 1.40 and the typical setting for the control variable f_YUV_color is 1.39.

```
    HRESULT CWmpvideotest::ProcessYUY2( BYTE
*pbInputData, BYTE *pbOutputData)
    {
    char DfxByAllStr[64];
    DWORD DfxByAll;
    DWORD sz_val_size;
    DWORD dwWidth = 0; // Video Image frame pixel width
    DWORD dwHeight = 0; // Video Image frame pixel height
    LONG lStrideIn = 0;  // Stride in bytes.
    LONG lStrideOut = 0; // Stride in bytes.
    // These pointers will point to the actual image pixel
data.
    BYTE *pbSource = NULL;
    BYTE *pbTarget = NULL;
    // Get video frame output 18 size information
    GetVideoInfoParameters( pbOutputData, &dwWidth, &dwHeight,
    &lStrideOut, &pbTarget, true);
    // Get video frame input 16 size information
    hr = GetVideoInfoParameters( pbInputData, &dwWidth, &
    dwHeight,
    &lStrideIn, &pbSource, true);
    // YUY2 memory layout
    //
    // Byte Ordering (lowest first)
    // Y0 V0 Y1 U0
    //
    // 1 Macro pixel = 2 image pixels
      {
      unsigned int i;
      unsigned short int min = 255;
      unsigned short int max = 0;
      unsigned short int out_min = 255;
      unsigned short int out_max = 0;
      unsigned short int tmp;
      int num_pixels = 0;
      float scale, out_scale;
      unsigned short int breakpoint;
      unsigned int pixels_summed = 0;
      float average_pixel_val;
      unsigned int num_pixels_over_threshold = 0;
      float fraction_pixels_over;
    // dwWidth and dwHeight came from the input buffer.
    DWORD y = dwHeight;
    {
      // Find min and max of Luma Y plane, Y vals are every
other point
      // Implements the video analyzer 47 element
      for(i=0; i<dwHeight * lStrideIn; i += 2)
      {
        tmp = (unsigned short int)pbSource[i];
        if( tmp > max )
          max = tmp;
        if( tmp < min )
          min = tmp;
        num_pixels++;
        pixels_summed += tmp;
        if( tmp > (unsigned short int)(f_YUV_threshold * 255.0)
)
      num_pixels_over_threshold++;
    }
    if(num_pixels > 0)
    {
      average_pixel_val = (float)pixels_summed/(float)(num_{—}
pixels * (float)255.0);
      fraction_pixels_over = (float)num_pixels_over_threshold/
(float)num_pixels;
    }
    else
    {
      average_pixel_val = (float)1.0;
      fraction_pixels_over = (float)1.0;
    }
    // Add brightness gain after Auto scaling has been done.
    // Implements image brightness adjuster 43 element
    {
      // Adjust range so that min will be 0, max will be 255
      scale = (float)((255.0)/(double)(max − min));
      for(i=0; i<dwHeight * lStrideIn; i += 2)
      {
        tmp = (unsigned short int)( (pbSource[i] − min) *
scale * f_YUV_brightness + (float)0.5 );
        if(tmp > 255)
          tmp = 255;
        pbTarget[i] = (BYTE)tmp;
      }
    }
    // Now process U and V bytes. Ordering - Y0 V0 Y1 U0 ,
below processes V then U bytes
    // Implements the image color saturation adjuster 36
element
    for(i=0; i<dwHeight * lStrideIn; i += 2)
    {
      long temp;
      temp = (long)((pbSource[i + 1] − 128) * f_YUV_color);
      // Truncate if exceeded full scale.
      if (temp > 127)
                temp = 127;
            if (temp < −128)
                temp = −128;
            // Set frame output values
            pbTarget[i + 1] = (BYTE) (temp + 128);
          }
        }
        else
          memcpy( pbTarget, pbSource, dwHeight * lStrideIn );
      }
      return;
    }
```

Note that in the implementation shown in the table above, a variable named average_pixel_val is calculated and later used in the method of adjusting the overall brightness of the image. The method thus makes adjustments of the overall image brightness to keep it in a useful range for best display of the image, so that images that are overly dark will be adjusted to be brighter and images that are overly bright will have the brightness reduced. This is very similar to the functionality of the audio enhancement processing shown in FIG. 2 where we have seen that the processing system adjusts the audio level to make audio files from different sources all have the same average sound level.

It is straightforward to apply this same method to insuring that the average color intensity of the processed video is the same for different input video files. This is shown in the additional C++ source code listing in the table below.

```
    // Find average color value
    for(i=0; i<dwHeight * lStrideIn; i += 2)
    {
      tmp = ((pbSource[i + 1] − 128)); // Finds color value
of pixel
      num_pixels++;
      color_vals_summed += tmp;
    }
    if(num_pixels > 0)
    {
      average_color_val = (float) color_vals_summed /(float)
(num_pixels * (float)255.0);
    }
    else
    {
      average_color_val = (float)1.0;
      fraction_pixels_over = (float)1.0;
    }
```

The line in the prior source code listing table that shows the modifcation of the pixel color intensity values, repeated below:

temp=(long)((pbSource[i+1]−128)*f_YUV_color);

is then modified to include an adjustment for the average color intensity as shown below:

alpha=0.9; //Can be adjusted by user for most pleasing display properties

color_boost=(1.0−alpha)+alpha*(STANDARD_COLOR_VAL/average_color_val);

temp=(long)((pbSource[i+1]−128)*f_YUV_color*color_boost);

The preferred setting for the fixed parameter STANDARD_COLOR_VAL used in the color intensity modification shown above is the average value of the full range of color values settings, so for example if that range is 0 to 256 then the value for STANDARD_COLOR_VAL is 128.

With the additional functionality shown in the table above, the system now adjusts both the video image brightness and video image color intensity so that in addition to the automatic image brightness adjustment described above, the method also adjusted images that are somewhat colorless to be more colorful and images that are overly colorful to be less so. Note that the alpha parameter shown above is controlled by the display properties and settings 52 element for best performance depending on the video display type. For an LCD display type the preferred setting of the alpha parameter is 0.9. For a CRT display type the preferred setting for the alpha parameter is 0.92. For a LCD-LED display type the preferred setting for the alpha parameter is 0.91.

Thus for audio-video files that come from a variety of different sources and have different average levels of audio level, image brightness and image color intensity, the implementation shown above of the system of FIG. 1 causes the enhanced versions of those audio-video files to have very similar average levels fo audio volume level, image brightness and image color intensity. This provides a much more pleasing user experience when watching and listening to audio-video files that come from a variety of different sources.

Many additional methods can be used to implement the video analyzer 47 element of FIG. 3 that share this same useful property of adjusting the image brightness, constrast and color intensity so that audio-video files from a variety of different sources will automatically playback with very similar average values of image brightness, contrast and color intensity.

FIG. 3 shows the image color saturation adjuster 36, image contrast adjuster 39 and image brightness adjuster 43 elements as processing the video image in a particular order, but the order of the is processing can be changed to any possible ordering of those three elements while still providing good performance.

An additional function of the recorded media destination 23 element of FIG. 1 is to create and embed inside the recorded media destination 23 object the id tag 24 element shown in FIG. 1. The function of the id tag 24 element is to allow the recorded media source 10 element to detect if the media enhancement processing of FIG. 1 has already been placed on the recorded media source 10.

The id tag 24 element is placed in the recorded media destination 23 element as part of the process of assembling the final stored output object of the recorded media destination 23 element. The method for including the id tag 24 will vary depending on the format of the video and/or audio encoder that was implemented in the media re-encoder 20 element.

In the case where the audio re-encoder component of the media re-encoder 20 element implemented an mp3 encoder, the preferred implementation of the id tag 24 element is to insert what is commonly referred to as an “mp3 tag” in the header file of the created mp3 file. The methods for correctly inserting mp3 tags are straightforward and well known and are publically documented at sources such as www.id3.org <http://www.id3.org>. The preferred method of inserting the id tag 24 is to use what is described in the public specifications as a “comment” tag. Mp3 comment tags allow the insertion of a text comment string of chosen length. This comment string is then set to a unique indentifier, for purposes of example such as:

AUDIO_ENHANCEMENT_ID_A79B8C

The mp3 header comment tag then becomes a component of the mp3 file created by the recorded media destination 23 element, and stays contained in the file when the file is transferred to different locations, such as being copied to a different PC or being copied to a portable audio player or being uploaded to an internet file server and then downloaded from that file server on to a different PC or on to a portable audio player.

In a similar fashion, using methods that are well known and straightforward, in the case where the encoder implemented in the audio re-encoder component of the media re-encoder 20 element is an AAC encoder, the preferred implementation of id tag 24 element of FIG. 1 is to use what is described as an “UUID atom” that is inserted in the header component of the created AAC file using the file header specifications available from Apple Computer for AAC format files. The UUID atom would then be set to contain the same AUDIO_ENHANCEMENT_ID_A79B8C Id string described in the example above.

The wide majority of other audio formats in use today such as Microsoft's .wma format also support documented and well understood methods for inserting strings such as the example AUDIO_ENHANCEMENT_ID_A79B8C string into the file header or similar component of those formats files. Thus the general methods described for inserting the id tag 24 element into these other publically documented formats are well understood and straightforward to implement.

When the recorded media source 10 element contains a video component, the Id tag 24 element can be inserted in the video component of the recorded media destination 23 element in a similar manner as has been described for the audio component, as the methods for inserting tags in video files are very similar to the described methods for inserting tags in audio files.

The recorded media source 10 element of FIG. 1 that has been described has the additional function of checking for the presence of the id tag 24 element in the recorded media source 10 object. In the case where the format of the recorded media source 10 is an mp3 file, using well understood and straightforward to implement methods, the recorded media source 10 element will check the header of the mp3 file for the presence of a comment field containing the AUDIO_ENHANCEMENT_ID_A79B8C example id string. If this string is present then it shows that this mp3 file has already had the audio enhancement processing of FIG. 1 placed on the mp3 file, and the system of FIG. 1 is signalled to stop as no additional enhancement is needed. If a comment field containing the AUDIO_ENHANCEMENT_ID_A79B8C example id string is not detected in the header of the mp3 file then the mp3 file has not been enhanced with the processing of FIG. 1, and the processing of FIG. 1 is performed to create the enhanced audio file generated by the recorded media destination 23 element.

When the recorded media source 10 element represents a file in other formats, such as the AAC or Microsoft .wma format, in a similar fashion using well understood and documented methods the recorded media source 10 element checks the headers of these formats for the presence or absence of the AUDIO_ENHANCEMENT_ID_A79B8C example id string to determine if the processing of FIG. 1 should be performed on the recorded media source 10.

There are some formats, such as the CD track format that do not directly support the embedding and detection of header comments or id strings as has been described above. For these formats alternative systems can be implemented to allow the use of the id tag 24 element that has been described. One approach is to use one of the “watermarking” systems as are described at www.watermarkingworld.org <http://www.watermarkingworld.org>. Described are implementation systems to insert and detect embedded textural information directly in an audio file. In the case of a CD track, if the system of FIG. 1 is used to create an enhanced version of the CD track, the recorded media destination 23 element would use a specific watermarking implementation to embed the AUDIO_ENHANCEMENT_ID_A79B8C id string directly in the audio signal of the CD track, which would then be used as the master track for manufacturing the CD's.

If that CD track was then used as the recorded media source 10 of FIG. 1, the recorded media source 10 element would then implement the detection system of that same specific watermarking implementation system and if the watermarking detection system detected the AUDIO_ENHANCEMENT_ID_A79B8C id string then the system of FIG. 1 would be stopped as no addition enhancement would be required.

An alternative system to implement the id tag 24 elements for formats such as CD tracks that do not support the embedding and detection of header comments or id strings is to implement a central and publically available data base that specifies if a particular CD audio track has been enhanced with the system of FIG. 1. There are systems available from www.gracenote.com <http://www.gracenote.com>, www.freedb.org <http://www.freedb.org> and www.musicbrainz.com <http://www.musicbrainz.com> that generate a unique numerical ID value for any newly generated CD audio track. With this id tag 24 implementation when the recorded media destination 23 element represents a CD track, the unique numerical ID value for this newly created track is generated using one of these methods with the www.gracenote.com <http://www.gracenote.com> method selected for the purposes of this example, and that ID number is then written in a central database, signifying that this newly created CD track has been enhanced by the processing of FIG. 1.

When this CD track is then used as the recorded media source 10 element, for example as would be the case if the user of a PC system that implements FIG. 1 was using the system to “rip” this specific CD track to an mp3 format file then the recorded media source 10 element would first use the www.gracenote.com <http://www.gracenote.com> method selected above to generate the unique numerical ID value for this CD track. The recorded media source 10 element would then connect to the central database described above to check for the presence of that unique ID value. If that ID value is present in the database then that specific CD track has already been enhanced by the processing of FIG. 1 and the processing would then not be applied to the recorded media source 10 as the CD track is converted into the desired mp3 format file.

For the purpose of example the discussion above used a CD track as the recorded media source 10 in describing the watermark and database systems for implementing the id tag 24. However it is straightforward to in a similar fashion make use of the watermark and database systems to implement the id tag 24 element with any audio or video format to that does not have direct support for inclusion of the id tag 24 such as a header.

The media enhancement system shown in FIG. 1 can be implemented as a pure software based system running on either a personal computer (PC) or a specialized microcontroller or microprocessor. The system can also be implemented using a fully hardware based system, for example with the processing steps described implemented using general purpose logic elements, ASIC or FPGA based technologies. The system can also be implemented using a combination of software and hardware based implementation.

A typical software based implementation would be to use a PC to implement the processing steps of FIG. 1 by writing a program that implements all the processing steps of FIG. 1 in a similar fashion to the source coding listings that have been included in this description. In this implementation the recorded media source 10 could typically be an mp3 file that the PC user had downloaded for playback on to the PC or could be a video-audio file such as a .wmv file. Running the program would then process this mp3 or .wmv file with the elements of FIG. 1, and would create a processed and enhanced mp3 or .wmv file as the recorded media destination 23 of FIG. 1. The enhanced mp3 or .wmv file would include the embedded id tag 24 string that has been described above.

This processed and enhanced mp3.wmv file would then be used for playback and listening on the PC, or in the case where the user wished to listen to and/or view the output file on a portable audio-video media player like the iPod, the iTunes application from Apple Computer would then be used to load the modified mp3 or .wmv file on the users iPod for playback.

An alternative usage of the PC implementation described above would be to use a track on an audio CD placed in the CD-ROM drive of the PC as the recorded media source 10 of FIG. 1. The software implementation of the system would then read and de-code the audio CD track for enhancement by the system of FIG. 1, typically to create a processed mp3 file as the recorded media destination 23 of FIG. 1. This basic functionality of creating an mp3 file from a CD track is referred to as “ripping” and in this case the ripping is performed with the additional advantage of the audio enhancement of figure being applied to the resulting mp3 track. The enhanced mp3 file would include the embedded id tag 24 string that has been described above.

In both the cases as described above the recorded media destination 23 element would place an id tag 24 element in the resulting output file using the method described above so that an additional un-needed enhancement operation is not accidentally performed later on the recorded media destination 23 output file, even if that file is transmitted in some manner to a different PC. In the first description of the PC based software implementation the recorded media source 10 element of FIG. 1 would check for the presence of the id tag 24 element as has been described above so as to not perform additional enhancement if the recorded media source 10 had already been enhanced.

The system of FIG. 1 could also be implemented using either a pure software, software/hardware or pure hardware approach on a portable media player similar in function to an iPod. In this case the system would be directly available on the iPod-like device to process and enhance all the audio or audio-video files that had been previously loaded on the device without requiring the use of a PC to process and re-load the files. Typically on the iPod like device, the user would select a file that they wished to be enhanced. The iPod device would then start the program that implements FIG. 1 on its internal microprocessor, and the program would perform all the steps of FIG. 1 to create the recorded media destination 23 output file directly on the iPod device so that it would then be immediately available for playback.

As has been described the processing system of FIG. 1 performs the function of making the output files created by the recorded media destination 23 element very similar in average audio output level and average video brightness and color saturation levels through its usage of the audio level estimator 33 element to control the gain value used by the dynamic boost 29 element and through the use of the video analyzer 47 element to adjust the video brightness and video color saturation. However there may be some implementation cases where this matching of audio and video file levels is not desired or for computational power limitations is too costly to implement.

In this case the internal operations of the audio level estimator 33 of FIG. 2 can be eliminated, and when this is done the value of the output 34 of the audio level estimator 33 is set to a fixed gain value to apply to the audio signal, and in this case the dynamic boost 29 element uses this gain value at its input 31 to directly set the gain applied to the signal undergoing processing by the dynamic boost 29 element. In the preferred embodiment of the dynamic boost 29 shown in the source listing above, in this case the variable boost is set directly to the desired gain value rather than being calculated as was shown above as an inverse function of the calculated song rms level value. For example if no gain change is desired on the created output files the boost level is set to 1.0. If a 3 db gain increase on the created output files is desired the boost value is set to 1.4142. In this case although the average output level of the created files may not match there will still be a substantial increase in the audio quality through the use of this special configuration of the processing of FIG. 2.

A substantial advantage of the preferred embodiment of the dynamic boost 29 element that has been described over the other described embodiments of that element is that it processes the audio in a manner that allows a much higher usable audio gain setting without causing distortion. This gain setting is shown in the source code listing for the preferred embodiment as the parameter boost. When using the preferred embodiment of the dynamic boost 29, in both of the functional cases of the audio level estimator 33 that have been described, the first case where the estimator generates the level estimate and the second case where the estimator is not functional and outputs a fixed gain value, in the preferred embodiment the boost value will be greater than 1.0, meaning that the average audio level of the recorded media destination 23 will be greater than the average audio output level of the recorded media source 10.

This is a significant advantage of the preferred embodiment of the dynamic boost 29 as it means when using audio playback systems with limited headroom such as portable audio players the enhanced recorded media destination 23 file will be capable creating a much a higher undistorted output level on that playback system than the un-enhanced recorded media source 10 file.

The system shown in FIG. 1 and detailed in FIGS. 2 and 3 processes audio-video files in a unique manner that first decodes them from their data compressed format, performs enhancement processing on both the audio and/or video components of the files that both improves their quality while also setting the audio level and image brightness and color saturation levels to standard values. This provides the user with both improved audio and visual quality while also providing a much more enjoyable listening and viewing experience as even with audio-video files from a variety of different sources the average audio level and average image brightness and color saturation are adjusted to be very consistent. Without this processing, listening to and viewing these same files would result in average audio levels that varied widely along with average image brightness and color saturation levels that also varied widely, leading to a less satisfactory listening and viewing experience.

The system shown in FIG. 1 and detailed in FIGS. 2 and 3 performs well when the decoding methods used in the media decoder 14 element and the encoding methods used in the media re-encoder 20 element are of the same type and data bit rate.

However, the system of FIG. 1 offers improved performance when the quality and/or data bit rate of the encoders used in the media re-encoder 20 element are higher than the quality and data bit rate that were used to encode the recorded media source 10 element. For example, if the recorded media source 10 element is a DVD that used the MPEG-2 video encoding standard to encode the video component and the MPEG-1 Layer 2 audio encoding standard to encode the audio component, then if the recorded media destination 23 element uses the higher quality MPEG-4 AVC video encoder to encode the video component and the higher quality AAC audio encoder to encode the audio component, then the media enhancement system of FIG. 1 will provide even higher quality in the displayed video and audio.

The system of FIG. 1 provides unique advantages not only when using the audio and video processing methods of FIG. 2 and FIG. 3 but also when using a wide variety of well known and understood methods to implement audio and video enhancement methods represented by the media processor 17 element of FIG. 1.

The system of FIG. 1 has particularly unique advantages when using one of the wide variety of well known and understood methods to implement the audio and video enhancement methods represented by the media processor 17 element of FIG. 1 while also using higher quality and data bit rate encoding methods in the recorded media destination 23 element than were used in the original encoding of the recorded media source 10 element. In this case the higher quality provided by the higher quality encoders in the media re-encoder 20 element allow the audio and video enhancements performed in the media processor 17 element to be more apparent in the final recorded media destination 23.

The display properties and settings 52 element of FIG. 3 provides the unique advantage of the allowing the video analyzer 47 element to make the best settings of the image color saturation, image contrast and image brightness for a particular video display type, such as LCD, Plasma or LCD-LED display types.

As an implementation example, if the media enhancement system of FIG. 1 were implemented as a software program on a Microsoft Windows based personal computer (PC), the software program would implement the functionality of FIG. 1 in the following manner. The recorded media source 10 element would represent the file based access to a Windows format .wmv audio-video media file. As a first step, the program would read the media file to check for the presence of the Id tag 24 element. If the tag is present the system stops operation as this media file has already been enhanced by the system of FIG. 1 and requires no additional enhancement.

If the Id tag 24 is not present, the program continues operation and would read a buffer sized portion of that media file and pass it to the media decoder 14 element. The media decoder 14 would apply the appropriate audio and video decoder methods and pass the buffers of decoded audio and decoded video in the temporary internal representation to the media processor 17 element.

The media processor 17 element would then separately apply the audio enhancement processing of FIG. 2 to the audio component buffer and the video enhancement processing of FIG. 3 to the video component buffer. These buffers of enhanced audio and video components are then passed to the media re-encoder 20 element. The media re-encoder 20 element then applies the appropriate audio encoder to the audio component buffer and the appropriate video encoder to the video component buffer.

As has been described the system of FIG. 1 provides a significant quality increase when the media re-encoder 20 uses the same encoder type and data rate as was used in the original encoding of the recorded media source 10. However as has also been described, even better quality can be achieved by using encoding methods in the media re-encoder 20 that use a higher data rate and/or improved encoding methods.

After the re-encoding has been performed by the media re-encoder 20, the audio and video buffers are passed to the recorded media destination 23 element. In this example this represents the final file location for the enhanced media file, which is created by using standard file write subroutine calls provided by the Windows operating system. As a final operation, the recorded media destination 23 element inserts the Id tag 24 in the output file to signify that it has been enhanced by the system of FIG. 1.

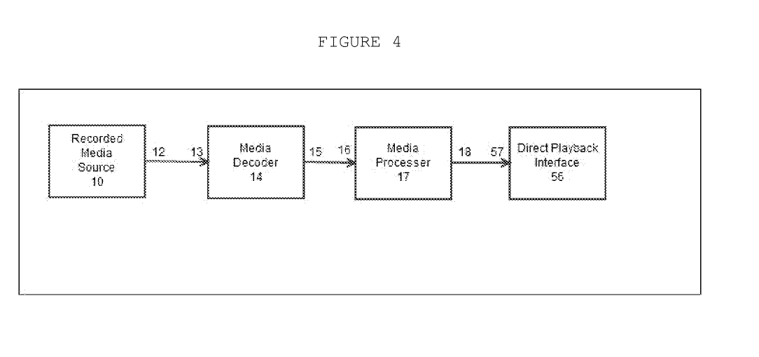

FIG. 4 shows a modified version of the media enhancement system of FIG. 1. The system of FIG. 4 is the same as the system of FIG. 1 with the exception that the media re-encoder 20 and recorded media destination 23 elements are not used in the system, and instead the direct playback interface 56 element is used.

Specifically whereas in FIG. 1 output 18 of the media processor 17 connects to input 19 of the media re-encoder 20, in FIG. 4 output 18 of the media processor 17 connects to input 57 of the direct playback interface 56 element, and the recorded media destination 23 element is not present in the system of FIG. 4.

FIG. 4 represents the media enhancement system in a configuration to provide immediate playback of the enhanced media file rather than the re-recording of the enhanced media file that is performed in FIG. 1 that allows playback at a later time. After the audio-video file has been enhanced by the media processor 17 of FIG. 4, it passes the enhanced audio-video components to input 57 of the direct playback interface 56 element. The direct playback interface 56 element then directly passes the audio and video components to the audio sound playback and video display devices for immediate synchronized listening and viewing.

For example if the system of FIG. 4 were implemented as a software program on a Microsoft Windows based personal computer (PC), the software program would implement the functionality of FIG. 4 in the following manner. The recorded media source 10 element would represent the file based access to a Windows format .wmv audio-video media file. The program would read a buffer sized portion of that media file and pass it to the media decoder 14 element. The media decoder 14 would apply the appropriate audio and video decoder methods and pass the buffers of decoded audio and decoded video in the temporary internal representation to the media processor 17 element.

The media processor 17 element would then separately apply the audio enhancement processing of FIG. 2 to the audio component buffer and the video enhancement processing of FIG. 3 to the video component buffer. These buffers of enhanced audio and video components are then passed to the direct playback interface 56 element for immediate playback.

In the case of this example, this playback is typically performed by making subroutine calls to the special Windows functions that provide audio and video playback on Windows PC's. Note that for the system of FIG. 4 to provide continuous playback of the enhanced audio-video signal, the PC must be capable of performing the operations of FIG. 4 at a buffer processing rate at least as fast as the required buffer playback rate need for continuous playback of the file.

A specific case of the implementation of the media processing system of FIG. 4 is the case where the recorded media source 10 element represents a source of “streaming” media. In this case the recorded media source 10 represents an audio or audio-video file typically located on a remote file server accessed through an internet connection. The “streaming” description refers to the fact that the media file is not supplied as a complete object, but is made available on a sequential buffered basis at a data rate that at least allows real time playback of the media file. In this case this streaming file can still be processed by the system of FIG. 4 with the restriction that the components that require access to the entire history of the input file, such as the audio level estimator 33, do not function, as has been described in an example above

The implementation of the media enhancement system of FIG. 4 allows an additional method of useful functionality. As this system processes audio-video files at close to the real-time playback rate, any adjustments to the settings of the system are immediately observed by the user of the system. This allows an interactive method of evaluation of the system. For this evaluation method the system is setup to allow switching between 2 operational modes.

The first mode is the normal operation of the system as shown in FIG. 4, allowing the user to observe and listen to the media as enhanced by the system of FIG. 4. The second mode is a special “bypass” mode of the system where instead of the direct playback interface 56 element taking its input from output 18 of the media processor 17, the direct playback interface 56 element temporarily takes its input directly from output 15 of the media decoder 14 element, thus temporarily bypassing both the audio and video enhancement processing.

Providing the user of the system of FIG. 1 with this ability to interactively place the system in the described bypass mode allows them to directly observe and compare the improvement in the audio sound quality and video display quality of the enhanced mode to the un-enhanced bypass mode. In addition, performing this bypass in the manner described will simultaneously switch both the audio and video enhancement processing on and off, yielding the best possible comparison method for the user of the system.

The media enhancement system shown in FIG. 4 is particularly unique and useful for improving both the video quality and audio quality of data compressed audio-video media files, both in streaming and non-streaming formats.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A recorded media enhancement method for improving the perceived quality of recorded media, comprising:
a recorded media source, for providing access to the unprocessed recorded media file;
a media decoder, for providing a means for decoding the recorded video and/or audio media from a compressed data format into a temporary internal high precision representation, functionally connected to said recorded media source;
a media processor, for providing a means for enhancing the quality of the decoded video and/or audio data, functionally connected to said media decoder;
a media re-encoder, for providing a means to re-encode the processed video signal and/or processed audio signal to a compressed data format, functionally connected to said media processor; and
a recorded media destination, for providing a destination for the enhanced recorded media file, functionally connected to said media re-encoder.

2. The recorded media enhancement method as recited in claim 1, further comprising:
an id tag, for providing a means for identifying the recorded media destination as having been enhanced by this method, functionally embedded to said recorded media destination.

3. The recorded media enhancement method as recited in claim 1, further comprising:
an audio processor, for providing a means for performing the audio processing of the media processor using a means for a audio level estimator, a means for a spectral enhancer, a means for a headphone auralizer and a means for a dynamic boost, functionally connected to said media decoder.

4. The recorded media enhancement method as recited in claim 1, further comprising:
a video processor, for providing a means for performing the video image processing of the media processor using a means for a video analyzer, a means for an image color saturation adjuster, a means for an image contrast adjuster and a means for an image brightness adjuster, functionally connected to said media decoder.

5. The recorded media enhancement method as recited in claim 2, further comprising:
an audio processor, for providing a means for performing the audio processing of the media processor using a means for a audio level estimator, a means for a spectral enhancer, a means for a headphone auralizer and a means for a dynamic boost, functionally connected to said media decoder.

6. The recorded media enhancement method as recited in claim 2, further comprising:
a video processor, for providing a means for performing the video image processing of the media processor using a means for a video analyzer, a means for an image color saturation adjuster, a means for an image contrast adjuster and a means for an image brightness adjuster, functionally connected to said media decoder.

7. The recorded media enhancement method as recited in claim 3, further comprising:
a video processor, for providing a means for performing the video image processing of the media processor using a means for a video analyzer, a means for an image color saturation adjuster, a means for an image contrast adjuster and a means for an image brightness adjuster, functionally connected to said media decoder.

8. The recorded media enhancement method as recited in claim 5, further comprising:
a video processor, for providing a means for performing the video image processing of the media processor using a means for a video analyzer, a means for an image color saturation adjuster, a means for an image contrast adjuster and a means for an image brightness adjuster, functionally connected to said media decoder.

9. The recorded media enhancement method as recited in claim 1, wherein said media re-encoder is using higher accuracy encoding than used on the recorded media source by use of improved encoding methods and/or a higher encoding bit rate.

10. The recorded media enhancement method as recited in claim 2, wherein said media re-encoder is using higher accuracy encoding than used on the recorded media source by use of improved encoding methods and/or a higher encoding bit rate.

11. The recorded media enhancement method as recited in claim 3, wherein said media re-encoder is using higher accuracy encoding than used on the recorded media source by use of improved encoding methods and/or a higher encoding bit rate.

12. The recorded media enhancement method as recited in claim 4, wherein said media re-encoder is using higher accuracy encoding than used on the recorded media source by use of improved encoding methods and/or a higher encoding bit rate.

13. The recorded media enhancement method as recited in claim 5, wherein said media re-encoder is using higher accuracy encoding than used on the recorded media source by use of improved encoding methods and/or a higher encoding bit rate.

14. The recorded media enhancement method as recited in claim 6, wherein said media re-encoder is using higher accuracy encoding than used on the recorded media source by use of improved encoding methods and/or a higher encoding bit rate.

15. The recorded media enhancement method as recited in claim 7, wherein said media re-encoder is using higher accuracy encoding than used on the recorded media source by use of improved encoding methods and/or a higher encoding bit rate.

16. The recorded media enhancement method as recited in claim 8, wherein said media re-encoder is using higher accuracy encoding than used on the recorded media source by use of improved encoding methods and/or a higher encoding bit rate.

17. A recorded media enhancement method for improving the perceived quality of recorded media, comprising:
a recorded media source, for providing access to the unprocessed recorded media file;
a media decoder, for providing a means for decoding the recorded video and/or audio media from a compressed data format into a temporary internal high precision representation, functionally connected to said recorded media source;
a media processor, for providing a means for enhancing the quality of the decoded video and/or audio data, functionally connected to said media decoder;
an using higher accuracy encoding than used on the recorded media source by use of improved encoding methods and/or a higher encoding bit rate media re-encoder, for providing a means to re-encode the processed video signal and/or processed audio signal to a compressed data format, functionally connected to said media processor;
a recorded media destination, for providing a destination for the enhanced recorded media file, functionally connected to said media re-encoder;
an id tag, for providing a means for identifying the recorded media destination as having been enhanced by this method, functionally embedded to said recorded media destination;
an audio processor, for providing a means for performing the audio processing of the media processor using a means for a audio level estimator, a means for a spectral enhancer, a means for a headphone auralizer and a means for a dynamic boost, functionally connected to said media decoder; and
a video processor, for providing a means for performing the video image processing of the media processor using a means for a video analyzer, a means for an image color saturation adjuster, a means for an image contrast adjuster and a means for an image brightness adjuster, functionally connected to said media decoder.
